(19) United States
(12) Patent Application Publication
(10) Pub. No.: US 2018/0029705 A1
(43) Pub. Date: Feb. 1, 2018

(54) Mano supersonic cockpit

(71) Applicant: Bernard Ashby, BRONX, NY (US)

(72) Inventor: Bernard Ashby, BRONX, NY (US)

(73) Assignee: Bernard Anthony Ashby, Bronx, NY (US)

(21) Appl. No.: 15/330,036

(22) Filed: Jul. 29, 2016

(51) Int. Cl. B64C 30/00; B64C 1/00

(52) U.S. Cl. CPC B64C 30/00; B64C 1/00

(57) ABSTRACT

This is the Mano Supersonic Cockpit wish is the cockpit of a supersonic passenger aircraft place in as far front of the nose of the aircraft as possible to avoid the need for the nose of the supersonic aircraft dropping for landing and then straightening out for supersonic flight.

### BRIEF SUMMARY

This is the Mano Supersonic Cockpit. The cockpit of a supersonic jet usually placed in the front fuselage. this creates the need for a nose that drops when the plane is landing or taking. The Mano Supersonic Cockpit places the cockpit as far to the front of the nose of the airplane as possible with enough space for one to two front eat pilots.

### DETAIL DESCRIPTION

This is the Mano Supersonic Cockpit. This invention is the cockpit of a supersonic aircraft placed in the nose of the aircraft. Today supersonic passenger aircraft such the retired concord has to drop the nose of the aircraft for landing and for flying at supersonic speed must straighten out the nose of the aircraft for supersonic flight. This problem can be avoided by the cockpit being placed in the nose of the aircraft. An example of how small the space of a cockpit can be with two pilots is the Sukhoi Su-24 a supersonic fighter jet. With this invention the cockpit is so far to the front of the aircraft that the need to drop the nose to be able to land would be unnecessary. This technology is for a passenger supersonic jet and not a jet fighter which essentially has the cockpit on the nose of the airplane and the fuselage.

1. I claim the Mano Supersonic Cockpit which has the cockpit of a supersonic aircraft as far to the front of the nose of the aircraft as possible.

2. I claim the Mano Supersonic Cockpit which is in its best configuration has the cockpit designed for two pilots sitting side by side in the front nose of the supersonic passenger aircraft like the cockpit of the Sukhoi Su-24.
